(19) United States
(12) Patent Application Publication
(10) Pub. No.: US 2019/0083354 A1
(43) Pub. Date: Mar. 21, 2019

(54) MASSAGE DEVICE FOR PRESSURE WAVE MASSAGE

(71) Applicant: FUN FACTORY GMBH, Bremen (DE)

(72) Inventor: Michael Pahl, Delmenhorst (DE)

(73) Assignee: FUN FACTORY GMBH, Bremen (DE)

(21) Appl. No.: 16/084,956

(22) PCT Filed: Mar. 16, 2017
(86) PCT No.: PCT/EP2017/056265

§ 371 Date: Sep. 13, 2018

(30) Foreign Application Priority Data
Mar. 17, 2016 (DE) 10 2016 105 019.9

(51) Int. Cl. A61H 19/00; A61H 9/00

(52) U.S. Cl. CPC A61H 19/34; A61H 9/0007; A61H 2201/123; A61H 2201/0153; A61H 2201/0157; A61H 9/0057

(57) ABSTRACT

The invention relates to a massage device (1) for massage by means of pressure waves, comprising a housing (2) having a grip section (4) and a massage section (6), at least one first chamber (8, 10) having an opening (12) in the massage section, leading towards the outside, and a drive means (30) for changing the volume (V1) of the first chamber (8), wherein the drive means (30) has at least one coil element (32, 34) and at least one movably guided magnetic core (38) arranged parallel to the coil element (32, 34) for acting on the first chamber (8).

The invention relates to a massage device for massage by means of pressure waves, comprising a housing having a grip portion and a massage portion, at least one first chamber in the massage portion, at least one first chamber having an opening in the massage section, leading towards the outside, and a drive means for changing the volume of the first chamber.

For indirect stimulation of erogenous zones, and particularly the clitoris, conventional vacuum suction devices are used to arouse the erogenous zones of the person concerned without directly contacting the main area to be stimulated. For example, vacuum pumps for the primary or secondary female sex organs are known which usually have a suction cup for placement and a manual pump. The underpressure exerted with this kind of device, for example on the clitoris, produces a negative pressure in the clitoris itself, which is usually lower than the systolic blood pressure. This pressure differential causes the clitoris to swell and/or stimulates the flow of blood in the affected area. This clitoral vasoengorgement is useful for stimulating desire, not only by increasing sensitivity, but also by visual and tactile manipulation. Improved blood circulation also causes increased production of vaginal moisture, which makes stimulation more pleasant. Operating the pump manually is often annoying or bothersome, however. With this category of device as well, the use of underpressure over a longer term or uninterruptedly can also result in habituation effects which limit the effectiveness of the device in the long run. Moreover, simply increasing the flow of blood in the clitoris is often not enough to reach a climax; in many cases, vacuum pumps are therefore used in foreplay only, in order to reach climax subsequently using direct (pressure) massage of the erogenous zone.

Electrically driven vacuum pumps are also used increasingly instead of manually operated vacuum pumps. As an example, WO 2006/058291 A2 discloses a device for sexual therapy, in which the arrangement consists of a tubular suction chamber for the clitoris, an electric vacuum source (vacuum pump) and a plurality of airflow openings. The moist air which is sucked in results in contamination of the vacuum arrangement fluidically downstream, for example the vacuum pump. Such arrangements involving vacuum pumps can therefore be problematic with regard to their hygiene, as vacuum pumps and the associated valves or ventilation components often have dead spaces or blind spots and/or are difficult to clean. Furthermore, the device is used to treat the blood vessels of the clitoris, and not to provide stimulation until a sexual climax is reached.

U.S. Pat. No. 6,099,463 A discloses a clitoral stimulation device comprising a tubular suction chamber, a vacuum source or vacuum pump, and a plurality of valves with which the amount of vacuum is controlled. The vacuum can also be applied cyclically to produce a stimulation effect, although habituation effects are to be expected with this device also, due to a constant vacuum being used. The disadvantages in respect of hygiene and dehydration of the skin area to be stimulated, as mentioned above, arise here also. The pressure control arrangement comprising a plurality of valves, a vacuum pump, etc., is likewise relatively complex.

U.S. Pat. No. 6,464,653 B1 discloses therapeutic devices and methods that produce clitoral vasoengorgement with the aid of a vacuum generated by a vacuum pump, in order to support the treatment of clitoral disorders. The amount of vacuum in the suction chamber can be manually adjusted or varied with the aid of a control valve or modulator which can be covered accordingly by a finger. This requires the user's attention and may be bothersome or distracting in certain circumstances. This relatively complex device with additional valves also has the same disadvantages as mentioned above with regard hygiene and dehydration, although the device is also used for long-term therapeutic purposes and not for short-term sexual stimulation.

WO 2008/028076 A2 discloses a therapeutic device for women, which is mainly used for treating sexual disorders. The device involves a combination of indirect stimulation with the aid of a vacuum chamber and direct stimulation with the aid of mechanical vibrators and oscillators.

In this therapeutic device, the underpressure serves to increase the flow of blood in the clitoris, whereas the area of skin is actually stimulated or massaged directly using mechanical vibrations or oscillations. A suction cup for placing on the area of skin to be stimulated is internally connected to a motor by means of a mechanical connection. The suction cup is widened by the motor after activating the device, thus increasing the volume of the suction cup. The resultant volume of the suction cup and thus the strength of the vacuum can be adjusted by means of control elements on the device. The air displaced in the device by the suction process is released back to the outside via a pipe. In this device, the vacuum performs a supporting function only, whereas the actual stimulation is performed directly and thus involves the same disadvantages of direct stimulation as described in the foregoing.

US 2013/0012769 A1 discloses a device in which pulsating overpressure is used for stimulation by air pressure massage. A pump or compressor generates a pulsating overpressure which is directed with the aid of a nozzle onto the erogenous zone to be stimulated. This device disadvantageously causes the area of skin involved to dry out severely or completely. Similarly, there is usually a temperature difference between the temperature of the air being fed and the temperature of the area of skin to be stimulated, which may be experienced as bothersome in certain circumstances. The same hygiene problems as described above occur with this device also, and in this case any pathogens or germs or other forms of contamination in the device are also transported directly to the user's genital area.

The devices known from the prior art thus have in common the disadvantage that the complexity of the arrangements for generating the underpressure or overpressure is high, and that these devices may give rise to hygiene problems.

Such a massage device is basically known from WO 2015/039787 A1, which claims the priority of DE 10 2013 110 501. The stimulation device for erogenous zones, in particular for the clitoris, as disclosed therein, has a pressure field generator comprising at least one first chamber and at least one second chamber having at least one opening for placing onto a body part, and at least one connection element which connects the first chamber to the second chamber, and a drive unit which changes the volume of the first chamber in such a way that a stimulating pressure field is generated in the second chamber via the connection element, and a control device which controls the drive unit. The drive unit is provided in the form of an electric motor and drives the first chamber in such a way, via a drive shaft and by means of an eccentric or by means of a connecting rod, that the volume of the first chamber is changed according to the rotation of the drive shaft of the drive unit.

The disadvantage of this arrangement is its relatively complicated structure, the limited range of motion and therefore the limited ability to produce vibrations.

The object of the present invention is to specify such a massage device which is simpler in structure and can nevertheless produce a greater variety of different vibrations.

According to the invention, this object is achieved by the drive means having at least one coil element and at least one movably guided magnetic core arranged parallel to the coil element for acting on the first chamber.

When an electric current is applied to the coil element, a magnetic field is formed which interacts with the magnetic core in such a way that the latter is moved parallel to and preferably coaxially with the central axis of the coil element. Back-and-forth motion of the magnetic core can be produced by appropriately applying electric current to the coil element. This back-and-forth motion, that is, a vibration in the axial direction, can be influenced in both its frequency and amplitude by exciting the coil element accordingly. A great variety of vibrations can thus be generated, with the volume of the first chamber being varied according to the motion of the magnetic core due to the way the magnetic core acts on the first chamber. The result is a flow of fluid out of and into the first chamber and thus a flow of fluid out of the opening and into the opening, respectively, which corresponds to the excitement of the coil element. The change in the volume of the chamber therefore causes a pressure field to be formed in the chamber, and the pressure waves emanating from it can be used advantageously to massage particular parts of the body, in particular the female clitoris.

An example of such a pressure field is a field of media pressures which changes over time, which temporarily has overpressures and temporarily underpressures, an underpressure being a media pressure which is less than the reference pressure and an overpressure being a media pressure which is more than the reference pressure. Possible media include gaseous and/or liquid media, in particular, such as air or water. The massage device can be used advantageously when having a bath in the bath tub, for example, or also under the shower.

In a first preferred embodiment of the invention, the first chamber has a first chamber wall and the magnetic core is mechanically coupled to at least one actuation portion of the first chamber wall. The magnetic core is preferably coupled mechanically to the actuation portion of the first chamber wall so that when it moves it changes the volume of the chamber. The actuation portion can be a part of the chamber wall, for example a portion thereof which is designed to be flexible. The entire chamber wall may be made of a flexible material, with the magnetic core acts on that flexible chamber wall.

In another preferred embodiment, the actuation portion is provided in the form of a membrane. In this embodiment, the magnetic core acts on the membrane, which is preferably connected resiliently to the chamber wall. The membrane itself may be substantially stiff and is coupled via an annular spring portion, for example, to the rest of the chamber wall of the first chamber. The entire chamber wall of the first chamber may be substantially stiff, for example by being made of a plastic material.

In one particularly preferred embodiment, a direction of movement of the magnetic core is oriented substantially perpendicular to the actuation portion of the first chamber wall. As a result, the stroke length of the magnetic core is translated to a maximum extent into a change in volume of the chamber and can thus be used particularly effectively. The effectiveness of the device is increased as a result.

According to another preferred embodiment, the actuation portion has an area A1 on the inner side of the first chamber, and said inner side of the chamber has a total area A2, wherein the ratio of A1 to A2 is in a range of 0.1 to 0.8, preferably 0.1 to 0.7, further preferably 0.1 to 0.5, further preferably 0.1 to 0.4, further preferably 0.1 to 0.3, and further preferably about 0.2. It is desirable that the greatest possible change in the volume of the first chamber be achieved with a small stroke length on the part of the magnet. This provides the massage device with a very fast response, and the massage device as a whole is very efficient. It is also advantageous in this regard that, due to a large change in volume being achieved with a small stroke, the inertial forces acting on the massage device are only minor, which means that little or no shaking or vibrating of the massage device is perceived at the handle. The amount of noise produced is also reduced as a result.

It is particularly preferred that the drive means has a stroke ranging from about 1 mm to about 25 mm. It is further preferred that the stroke is in a range from 1 mm to 20 mm, from 1 mm to 15 mm, from 1 mm to 10 mm, from 3 mm to 7 mm and is particularly preferably about 5 mm. It is preferable that the magnetic core is not moved too intensely, i.e. that the stroke is not too large, because the massage device as a whole would then vibrate noticeably for a person operating it and noise could also be produced.

In one preferred development of the invention, the magnetic core has a mass ranging from 2 to 15 grams, preferably from 3 to 10 grams, and further preferably from 4 to 8 grams. Vibration of the toy during operation is to be prevented as far as possible. The intention is that the magnetic core drives the chamber or changes its volume on its own as far as possible, but does not cause the toy to vibrate during operation as a result of its inertia. It has been found that the vibration of the toys can be kept to a low level when a magnetic core with a weight in the aforementioned range is used, while still acting effectively on the chamber.

The total weight of the massage device is preferably in a range between 100 grams and 500 grams, preferably between 100 grams and 400 grams, further preferably between 100 grams and 300 grams, and further preferably between 100 grams and 200 grams. The total weight of the massage device is preferably in a range between 200 grams and 500 grams, preferably between 200 grams and 400 grams, and further preferably between 200 grams and 300 grams. The total weight of the massage device is preferably in a range between 300 grams and 500 grams, and preferably between 300 grams and 400 grams. The total weight is heavily dependent on the exact design of the massage device and its range of functions. For example, it is also conceivable to provide an additional vibrator drive to enable additional massaging of the clitoris. Such massage devices tend to be heavier.

In a preferred development of the invention, the ratio of the mass of the magnetic core (m1) to the mass of the massage device as a whole (m2) is preferably in a range from 1:6 to 1:250, preferably from 1:10 to 1:250, further preferably from 1:20 to 1:250, further preferably from 1:50 to 1:250, and further preferably from 1:100 to 1:250. The intention is that the magnetic core drives the chamber or changes its volume on its own as far as possible, but does not cause the toy to vibrate during operation as a result of its inertia. It has been found that the vibration of the toys can be kept to a low level when the weight ratios are in the aforementioned range, while it is still possible to act effectively on the chamber.

In one particularly preferred development of the invention, the magnetic core has at least two permanent magnets which are arranged with opposite poles facing each other. The whole magnetic field of the magnetic core is symmetrical as a result.

Accordingly, it is also preferred that two coil elements be provided that are preferably fed with current in opposite directions. A symmetrical arrangement overall is thus achieved, and the magnetic core can be kept in a middle position in a simple manner, and moved from that position in both the one direction and also in the other direction. Of course, two coil elements for one magnetic core can also be used with just one permanent magnet or in any other combinations, such as three coil elements with two permanent magnets, or four permanent magnets with one coil, or similar.

This prevents the magnet from escaping from the coil element in an uncontrolled manner. It also means that there is no need to provide end stops for the magnetic core. This also allows any noise to be reduced, as the magnetic core does not come into mechanical contact with end stops when it moves.

In another preferred embodiment, the permanent magnets each have a mass in a range from about 1 gram to about 10 grams and/or a magnetic flux density in a range from 0.38 T to 0.4 T. Neodynium magnets are preferred. These preferably have a diameter in a range from 5 mm to 15 mm and an axial length in a range between 3 mm and 5 mm.

It is also preferred that the coil element has a flux density in a range between 0.13 mT and 500 mT. This depends on the length of the coil and the number of windings. It has been found that a well-suited coil has about 50 to 200 windings, and specifically 100 windings, with an axial length between about 4 mm and 10 mm, in particular 10 mm. The flux density in this case is preferably about 13 mT.

According to one preferred embodiment, the magnetic core is arranged in a housing which is preferably coupled to a transmission rod which is provided to act upon the first chamber. The magnetic core is protected inside the housing, and the housing preferably serves to guide the magnetic core relative to the coil element. For example, the coil element may be arranged around a tube, such as a plastic tube or cardboard tube, and the housing is adapted in its outer dimensions to the inner diameter of the tube, so that the magnetic core can be guided substantially coaxially with the central axis of the coil element. The housing extends on one side into a transmission rod, which preferably is integrally moulded on the housing. The transmission rod is provided to act upon the first chamber.

In one variant, the housing is provided in the form of a thin-walled sleeve, for example as a heat-shrink tube. In the case where the magnetic core has two or more permanent magnets, these are preferably arranged together in the housing and are held at least partially by said housing. Although not imperative, it is preferable that the housing completely surrounds the magnetic core. If the housing is provided in the form of a sleeve, two end faces of the magnetic core may also be exposed.

In the case where the magnetic core has two or more permanent magnets, these are preferably separated from each other by a separating element. This simplifies assembly significantly. The permanent magnets are arranged with opposite poles facing each other, so the separating element helps to make it easier to attach the permanent magnets to each other. The separating element is preferably made of a plastic material in the form of a short pin, for example, at each of the two end faces of which a permanent magnet is attached, for example glued.

The transmission rod is preferably coupled to the actuation portion. The coupling can take the form of a mechanical connection, for example, such as a cardan joint, a simple screw connection, or adhesive bonding. It is particularly preferred that the transmission rod is integrally joined to the actuation portion of the chamber. This results in a particularly simple construction which provides an integrated drive means, on the one hand, and which can also be manufactured easily from the production engineering perspective, for example by injection moulding. There are also few coupling points that might be susceptible to failure, and there is no need for separate mounting of single elements.

A particularly preferred embodiment is one in which the massage device further comprises a second chamber, wherein the first chamber is an inner chamber and the second chamber has the opening leading to the outside and is in fluid communication with the first chamber. This results in the chambers being divided into two, the first inner chamber being coupled to the drive means, and the second chamber having the opening leading to the outside. The inner chamber is protected as a result, so the drive means is also protected.

In one preferred embodiment, the second chamber is substantially funnel-shaped and widens towards the opening. The opening is that portion of the massage device which leads to the outside. Such a funnel-shaped design serves to intensify the pressure waves, as is also known from horns. The pressure wave is widened as a result and can be used to massage a larger area.

In one preferred configuration, the first and second chamber are connected to each other by a connecting portion having a smaller cross-section than the opening. The connecting portion preferably has a smaller cross-section than the first chamber. The cross-section is preferably measured at the widest position in each case. An alternative is to measure average cross-sections. This means that fluid must initially flow out of the first chamber through the relatively narrow connecting portion until it reaches the second chamber. The connecting portion may be designed as a tube or as a constriction between the two chambers, and with a small axial extension. This increases the speed of flow in the connecting portion, with the result that, even when the volume of the first chamber changes only slightly, a relatively high-pressure pulse can be applied to the medium in the second chamber.

It is further preferred that the massage device has a controller for controlling the drive means to make the magnetic core vibrate in a predetermined manner with a predetermined vibration profile. The controller preferably includes a storage unit with a plurality of stored, predefined vibration profiles. A power source in the form of a rechargeable accumulator is preferably provided as well, by means of which the coil elements can be supplied with electric current. The controller is preferably coupled to at least one control knob on the grip section of the massage device. At least two control knobs are preferably provided, for example one control knob for switching the massage device on and off, and a second control knob for selecting a predefined vibration profile from the plurality of stored predefined vibration profiles vibration profiles.

The invention shall now be described in more detail with reference to one embodiment and with reference to the attached drawings, in which:

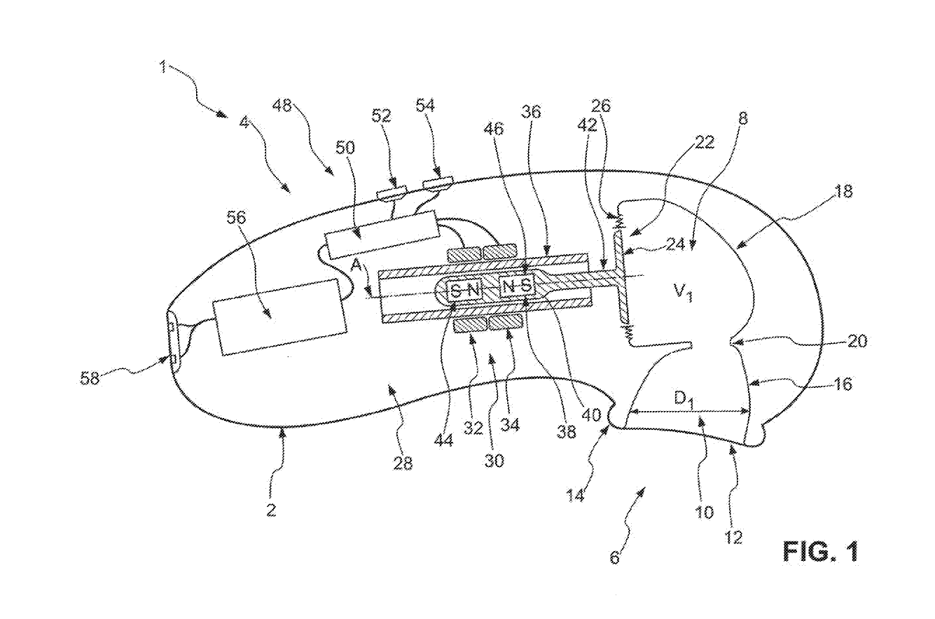

FIG. 1 shows a schematic cross-section through a massage device according to the invention;

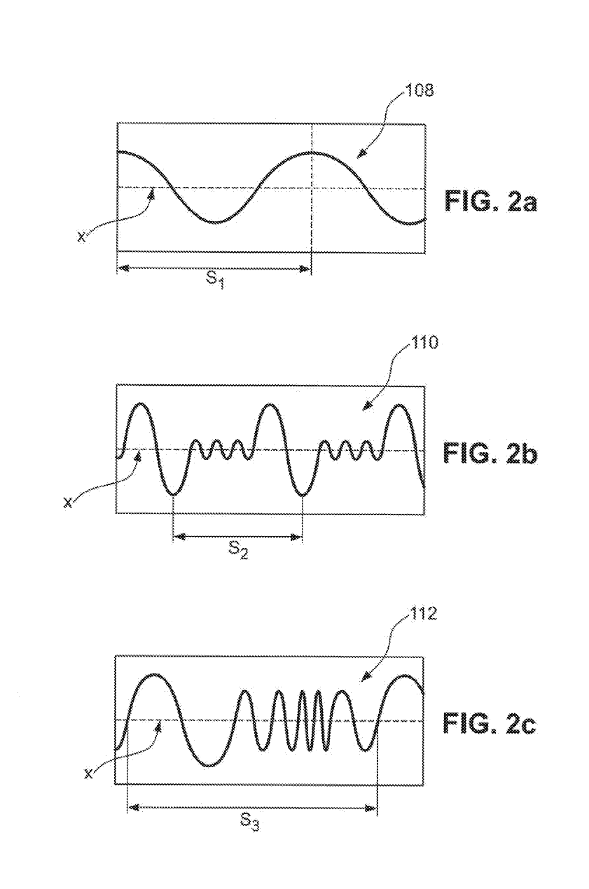

FIGS. 2A-2C show three vibration profiles;

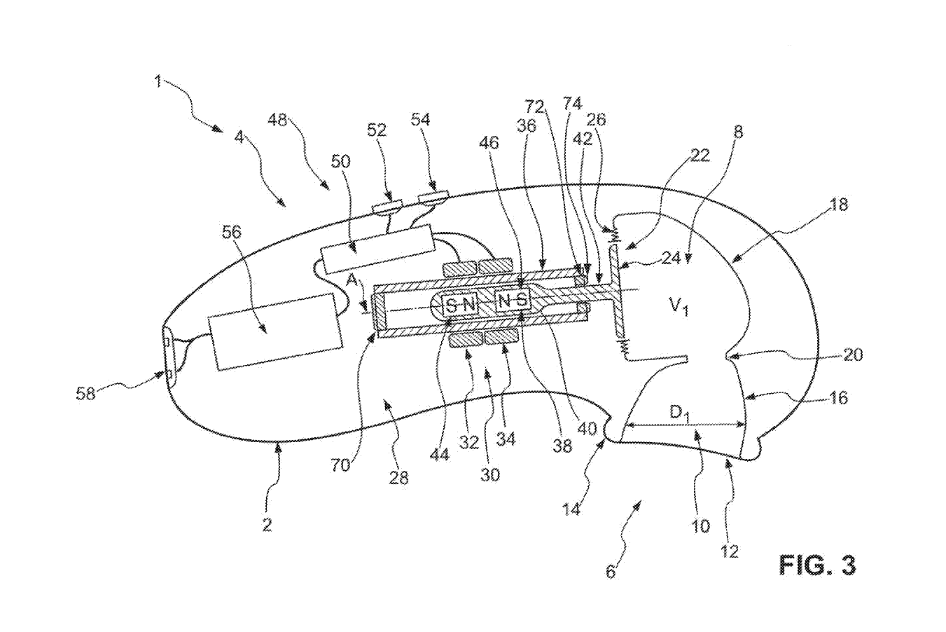

FIG. 3 shows a schematic cross-section through another massage device according to the invention;

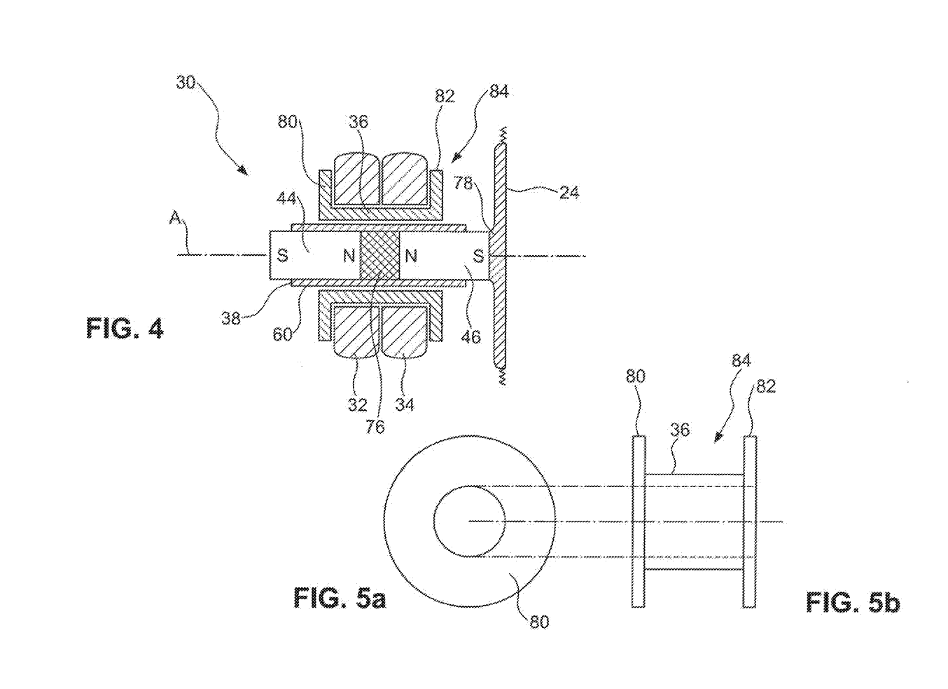

FIG. 4 shows a schematic cross-section through a drive means according to a second embodiment of the invention; and

FIGS. 5a, 5b show two views of a bobbin from FIG. 4.

A massage device 1 comprises a housing 2 having a grip section 4 and a massage section 6. In this embodiment, a first chamber 8 and a second chamber are provided inside housing 2. It should be understood that embodiments comprising only one chamber are likewise preferred.

Here, the second chamber 10 has an opening 12. In this embodiment, opening 12 is bounded by a lip 14 made of a soft and supple material. In embodiments having only one chamber, opening 12 is provided at the first chamber 8. The entire massage section 6 of massage device 1 is substantially made of a soft and supple material, such as a medical grade silicone. A diameter of opening 12 is selected so that it can be pleasantly placed onto the female sexual organ, in particular onto the clitoris. For that purpose, opening 12 may also have an elongated to oval shape and does not necessarily have to be circular in shape.

The second chamber 10 has a chamber wall 16 which is funnel-shaped overall and widens towards opening 12. The second chamber 10 is thus shaped like a horn for intensifying waves.

The first chamber 8 likewise has a chamber wall 18. Chamber wall 18 has a total inner area A1.

The first chamber 8 is in fluid communication with the second chamber 10 via a connecting portion 20. In this embodiment, connecting portion 20 is provided in the form of a constriction. The chamber walls 18 and 16 of first chamber 8 and of second chamber 10 are of integral construction, so there are no seams between the two chamber walls 16, 18, with the result that watertightness of massage device 1 can be ensured in a simple manner.

Chamber wall 18 of the first chamber 8 has an actuation portion 22, which is provided here in the form of membrane 24. Membrane 24 is connected to chamber wall 18 via an elastic suspension 26, which is likewise connected integrally to chamber wall 18. The suspension 26 is also integrally connected to membrane 24, such that the first and second chambers 8, 10 are sealed fluid-tightly against an interior space 28 of massage device 1. This prevents fluid, such as water, from entering interior space 28, thus allowing massage device 1 to also be used underwater.

Massage device 1 further comprises a drive means 30 for changing the volume V1 of the first chamber 8. Drive means 30 has two coil elements 32, 34. Coil elements 32, 34 are arranged around a guide tube 36. Although two coil elements 32, 34 are shown in the Figure, embodiments with only one coil element are also preferred. To change the direction of motion of the magnetic core, the polarity of the coil's magnetic field is reversed electrically in order to deflect the core proportionally. Three or more coil elements are likewise conceivable and preferred, although this involves more work to control them. Depending on the specific application, a coupled cascade comprising two or more drive means arranged coaxially one behind the other, or parallel beside each other, is preferred.

The guide tube may be of plastic or cardboard or the like. It should be understood that the guide tube is not obligatory. It can just as well be left out, without a substitute, if adequate guidance is provided in some other manner, for example by coil element 32, 34 itself.

A magnetic core 38 is guided inside guide tube 36. In this embodiment, magnetic core 38 is embedded in a housing 40, the outer diameter of which is a little smaller than the inner diameter of guide tube 36. Housing 40 has a substantially cylindrical shape and is arranged coaxially with axis A, which is the central axis of coil elements 32, 34 and simultaneously the central axis of guide tube 36.

Housing 40 is securely connected to membrane 24 via a transmission rod 42. In this embodiment, transmission rod 42 is integrally moulded onto membrane 24.

According to this embodiment, magnetic core 38 has two permanent magnets 44, 46, which are substantially cylindrical in shape. The two permanent magnets 44, 46 are identical, but are arranged with opposite poles facing each other. In this embodiment, the two north poles N face each other, whereas the south poles face away from each other. This results in a symmetrical magnetic field which is generated by magnetic core 38.

Massage device 1 also includes a controller 48 which has an electronic control unit 50. Two operating knobs 52, 54 with which massage device 1 can be operated are connected by means of electronic control unit 50, which can be provided in the form of a printed circuit board with appropriate electronic elements thereon. Control unit 50 is also connected to the two coil elements 32, 34 in order to supply them with electric current and the relevant signals. Controller 48 also includes a power source 56, which is provided in the form of a lithium-ion accumulator and which can be recharged by means of an appropriate plug via a connector 58.

Control switch 52 is used to switch on massage device 1, and selector switch 54 is used to select one of the predefined vibration profiles stored in control unit 50, according to which coil elements 32, 34 are supplied with electric current.

If magnetic core 38 is now moved to the right in FIG. 1, due to an magnetic field induced when coil elements 32, 34 are supplied with electric current, membrane 24 will also be moved to the right as a result, and the volume V1 of the first chamber 8 is made smaller. Any fluid in chamber 8 is compressed, and if, like water, it is not compressible, it is pressed through connecting portion 20 into the first chamber 10. This produces a wave pulse, due in particular to the increase in flow speed in section 20, under reduced pressure. The wave propagates through the first chamber 10 and exits from opening 12, where it strikes a body part of a user. A massaging effect is produced as a result.

If the magnetic core 38 is now moved correspondingly to the left, the volume V1 of the first chamber 8 is increased again, and a reversed pulse is generated.

FIGS. 2A to 2C that follow show three vibration profiles 108, 110, 112, which can be used to excite coil elements 32, 34. The vibration profiles indicate the motion of magnetic core 38, where zero line X, as shown in FIG. 1, illustrates a resting position of magnetic core 38, and an amplitude upwards in FIGS. 2A to 2C indicates a movement of magnetic core 38 to the right, that is, a movement to reduce the chamber volume.

FIG. 2A shows steady sinusoidal excitation, by which the chamber volume V1 is increased and decreased in size sinusoidally.

FIG. 2B shows a vibration profile consisting of three short oscillations with a small amplitude and a somewhat longer oscillation with a greater amplitude. This results in a pulsating form of stimulation that is experienced as particularly arousing.

Finally, FIG. 2C shows a vibration profile having a constant amplitude but varying frequency. The vibration profile begins with a relatively slow frequency which is then increased before it becomes slower again. A wave-like increase in frequency is thus provided, and a pulsating, wave-like pressure profile is provided at opening 12.

FIG. 3 shows the massage device 1 of FIG. 1, in which two impact elements 70, 72 are additionally provided. In both embodiments, identical parts are marked with the same reference signs, and reference is made in that respect to the entire description of FIG. 1 in the foregoing. For that reason, the following description mainly addresses the differences between the embodiments.

An impact element 70, 72 is arranged at each of the two axial ends of guide tube 36. Impact element 70 is of solid construction, and impact element 72 is provided with a through hole through which transmission rod 42 extends. Impact elements 70, 72 are used to prevent magnetic core 38 from leaving guide tube 36 and in particular from leaving the region surrounded by coil elements 32, 34. They are made of a rubbery elastic material, for example, so that magnetic core 38 can bounce off them and be thrown back. Alternatively, and preferably, impact elements 70, 72 are provided in the form of permanent magnets and are oriented with the same pole facing magnetic core 38, with the result that a repelling force is produced between magnetic core 38 and the respective impact element 70, 72. In this way, magnetic core 38 is always guided back to the middle. This is particularly useful when there are large deflections of membrane 24. If a liquid, such as water, is sucked into or expelled from inner chamber 8, and volume V1 increases or decreases, this may cause a suction effect and advantageously support magnetic core 38 in returning to its starting position. Depending on how chamber 8 is shaped, or also on the fluid that is used, it is preferred in this regard that the magnet forming impact element 70, or the magnet forming impact element 72 is stronger, in particular by 10%, 20%, 30%, 50% or 100% or more.

Impact element 72 may be additionally equipped with an impact part 74, which prevents the axial end face of guide tube 36 from coming into contact with the rear side of membrane 24. Impact part 74 may also be provided as a separate component and be arranged at the axial end face and/or on the membrane.

FIG. 4 shows a variant of drive means 30 from FIGS. 1 and 3. In this embodiment, magnetic core 38 is arranged in a housing 40 in the form of a sleeve 60. The two permanent magnets 44, 46 are separated by a separating element 76. In particular, permanent magnets 44, 46 are glued to separating element 76 such that opposite poles face each other. Sleeve 60 also extends over separating element 76, but has an axial length that is a little less than the length of magnetic core 38. In this embodiment, magnetic core 38 is directly connected to membrane 24, and in particular is glued to the membrane by means of an adhesive bond 78.

Guide tube 36 is also provided in this embodiment with a collar 80, 82 at each of its axial ends. In combination, guide tube 36 and collar 80, 82 thus form a bobbin 84. Coils 32, 34 are received between the two collars 80, 82. Assembly is significantly simplified as a result.

1. A massage device for massage by means of pressure waves, comprising
a housing having a grip section and a massage section;
at least one first chamber having an opening in the massage section, leading towards the outside; and
a drive means within said housing for changing the volume of the first chamber,
wherein the drive means has at least one coil element and at least one movably guided magnetic core arranged parallel to the coil element for acting on the first chamber,
wherein said magnetic core comprises at least one permanent magnet.

2. The massage device according to claim 1, wherein the first chamber has a first chamber wall and the magnetic core is mechanically coupled to at least one actuation portion of the first chamber wall.

3. The massage device according to claim 2, wherein the actuation portion is provided in the form of a membrane.

4. The massage device according to claim 3, wherein the membrane is resiliently connected to the chamber wall.

5. The massage device according to claim 2, where a direction of movement of the magnetic core is oriented substantially perpendicular to the actuation portion of the first chamber wall.

6. The massage device according to claim 2, wherein the actuation portion has an area A1 on the inner side of the first chamber, and the inner side of the chamber has a total area A2, wherein the ratio of A1 to A2 is in a range from 0.1 to 0.8, preferably 0.1 to 0.7, further preferably 0.1 to 0.5, further preferably 0.1 to 0.4, further preferably 0.1 to 0.3, and further preferably about 0.2.

7. The massage device according to claim 1, wherein the drive means has a stroke of 1 mm to 25 mm.

8. The massage device according to claim 1, wherein the magnetic core has a mass ranging from 2 to 15 grams.

9. The massage device according to claim 1, having a total weight in a range of 100 grams to 500 grams.

10. The massage device according to claim 1, wherein the ratio of the mass of the magnetic core to the mass of the entire massage device is in a range between 1:6 and 1:250.

11. The massage device according to claim 1, wherein the magnetic core has at least two permanent magnets which are arranged with opposite poles facing each other.

12. The massage device according to claim 1, comprising two coil elements arranged beside each other and substantially coaxially with each other.

13. The massage device according to claim 1, wherein the permanent magnets each have a mass in a range from 1 gram to 10 grams and/or a magnetic flux density in a range from 0.38 T to 0.4 T.

14. The massage device according to claim 1, wherein the coil element has a flux density in a range between 0.13 mT and 500 mT.

15. The massage device according to claim 1, wherein the actuation portion is arranged in a housing.

16. The massage device according to claim 15, wherein the housing is provided in the form of a thin-walled sleeve.

17. The massage device according to claim 15, wherein the housing completely surrounds the magnetic core.

18. The massage device according to claim 15, wherein the housing is coupled to a transmission rod which is provided to act upon the chamber.

19. The massage device according to claim 11, wherein the permanent magnets are separated by a separating element.

20. The massage device according to claim 2, wherein the magnetic core is attached directly to the actuation portion.

21. The massage device according to claim 2, wherein the transmission rod is coupled to the actuation portion.

22. The massage device according to claim 1, further comprising a second chamber, wherein the first chamber is an inner chamber and the second chamber has the opening leading to the outside and is in fluid communication with the first chamber.

23. The massage device according to claim 22, wherein the second chamber is substantially funnel-shaped and widens towards the opening.

24. The massage device according to claim 22, wherein the first and second chamber are connected to each other by a connecting portion having a smaller cross-section than the opening.

25. The massage device according to claim 22, wherein the first and second chamber each have a chamber wall of integral construction.

26. The massage device according to claim 1, having a controller for controlling the drive means to make the magnetic core vibrate in a predetermined manner with a predetermined vibration profile.
